(19) United States
(12) Patent Application Publication
(10) Pub. No.: US 2024/0167774 A1
(43) Pub. Date: May 23, 2024

(54) FLUID DISTRIBUTION TANK FOR A TUBE OF A HEAT EXCHANGER

(71) Applicant: VALEO SYSTEMES THERMIQUES, La Verriere (FR)

(72) Inventors: Matt SZYMCZAK, Troy, MI (US); Donald BOYD, Troy, MI (US)

(73) Assignee: VALEO SYSTEMES THERMIQUES, La Verriere (FR)

(21) Appl. No.: 18/058,051

(22) Filed: Nov. 22, 2022

(51) Int. Cl. F28F 9/22; F28F 1/02; F28F 1/06; H01M 10/613; H01M 10/643; H01M 10/6555; H01M 10/6557; H01M 10/6567; H01M 50/213

(52) U.S. Cl. CPC F28F 9/22; F28F 1/022; F28F 1/06; H01M 10/613; H01M 10/643; H01M 10/6555; H01M 10/6557; H01M 10/6567; H01M 50/213; F28F 2009/224; H01M 2220/20

(57) ABSTRACT

A fluid distribution tank for a flat tube of a heat exchanger, including: a top plate and a bottom plate coupled with each other to define a chamber with a tube opening. The top plate includes a top flat base and a top chamber base raised above the top flat base, while the bottom plate includes a bottom flat base and a bottom chamber base raised above the bottom flat base. The top and bottom chamber bases define the chamber. The top flat base is arranged in contact with the bottom flat base so that the top chamber base and the bottom chamber base are raised in the opposite directions. The chamber is divided into an inlet sub-chamber and an outlet sub-chamber by a division wall.

### TECHNICAL FIELD

The present invention relates to heat exchangers used for cooling batteries. More particularly, it pertains to a fluid distribution tank for a heat exchanger for cooling battery cells in electric and/or hybrid vehicles.

### BACKGROUND OF THE INVENTION

Thermal management system is vital for efficient operation of a battery pack in vehicles such as electric vehicles and hybrid-electric vehicles. The battery pack is an energy source of such a vehicle and provide required power to traction motors and other electric and/or electronic components. The battery pack includes a plurality of rechargeable battery cells and has a narrow operating temperature range, therefore the battery pack must be maintained within that specified operating temperature range to operate efficiently. During hot conditions and/or vehicle operating conditions, the battery pack needs to be cooled to maintain the temperature within the specified operating temperature range, whereas in cold conditions, the battery pack needs to be warmed to reach the optimum temperature. Deviation of battery pack's temperature from the specified temperature range can impede battery pack performance and reduce battery efficiency and durability. Sometimes, the batteries can be permanently damaged or destroyed due to deviation of the battery pack temperature outside the specified temperature range, and overheating of the battery cells can even result in fires and other safety related issues.

Typical thermal management system to cool and heat the battery pack relies on a number of subsystems such as a chiller, air-to-fluid heat exchanger, electric heater etc. The chiller or air-to-fluid heat exchanger are adapted for cooling the heat exchange fluid such as refrigerant or coolant in a battery loop to cool the battery pack, while the electric heater is adapted for heating the heat exchange fluid in the battery loop to increase the temperature of the battery pack.

Generally, heat exchangers can include multiple thermal cooling tube arrangements for cooling battery cells of the battery pack. Such a thermal cooling tube arrangement can include a thermal cooling tube with two sets of channels/micro-channels through which fluid/coolant circulates, an entry/exit tank at one end of the cooling tube, and a flow reversal tank at other end of cooling tube to allow the fluid to pass through the channels and follow the U-flow path. The thermal cooling tube arrangement is adapted for cooling of the battery cells that are indirectly in contact with the fluid/coolant circulating through the channels/micro-channels and following along a U-flow path. However, the existing end tanks of the exiting heat exchangers include complex component designs and complex joints, which increase the assembly time as well as manufacturing cost of the existing cooling tube arrangements or the heat exchanger.

Therefore, there is a need for a simple and robust end tank arrangement for thermal cooling tube, which can overcome the abovementioned problems associated with the existing end tanks of the exiting heat exchanger or the thermal cooling tube arrangement.

### BRIEF SUMMARY OF THE INVENTION

The object of the invention is, among others, a fluid distribution tank for a flat tube of a heat exchanger, comprising: a top plate and a bottom plate coupled with each other to define a chamber with a tube opening; wherein the top plate includes a top flat base and a top chamber base raised above the top flat base, while the bottom plate includes a bottom flat base and a bottom chamber base raised above the bottom flat base, the top and bottom chamber bases defining the chamber; wherein the top flat base is arranged in contact with the bottom flat base so that the top chamber base and the bottom chamber base are raised therefrom in opposite directions, wherein the chamber is divided into an inlet sub-chamber and an outlet sub-chamber by a division wall.

In one embodiment, the inlet sub-chamber and the outlet sub-chamber are further defined by chamber sidewalls extending between the top flat base and the top chamber base as well as between the bottom flat base and the bottom chamber base.

In one embodiment, the chamber sidewalls extend at least partly perpendicular to the top flat base, the top chamber base, the bottom flat base and the bottom chamber base.

In one embodiment, the top plate includes a top tube contact wall raised above the top flat base, while the bottom plate includes a bottom tube contact wall raised above the bottom flat base, so that the top tube contact wall and the bottom tube contact wall form a tube receiving portion of the tube opening.

In one embodiment, the top tube contact wall is raised from the top flat base lower than the top chamber base, while the bottom tube contact wall is raised from the bottom flat base lower than the bottom chamber base.

In one embodiment, the top chamber base includes an inlet top chamber base and an outlet top chamber base, while the bottom chamber base includes an inlet bottom chamber base and an outlet bottom chamber base, the inlet sub-chamber being formed by the inlet top chamber base and the inlet bottom chamber base, and the outlet sub-chamber being formed by the outlet top chamber base and the outlet bottom chamber base.

In one embodiment, the division wall is formed by portions of the top flat base and the bottom flat base being in contact.

In one embodiment, each of the inlet top chamber base, the outlet top chamber base, the inlet bottom chamber base and the outlet bottom chamber base includes an opening for the fluid.

In one embodiment, each of the inlet top chamber base, the outlet top chamber base, the inlet bottom chamber base and the outlet bottom chamber base has a flat surface with which the respective opening for the fluid is flush.

In one embodiment, top flat base and bottom flat base are brazed together.

In one embodiment, the fluid distribution tank has two side portions adjacent and extending perpendicular with respect to the tube opening and a back portion located opposite to the tube opening, wherein the top plate and the bottom plate are connected to each other by means of side crimping tabs located at the side portions and a back crimping tab located at the back portion.

In one embodiment, the fluid distribution tank has two side portions adjacent and extending perpendicular with respect to the tube opening and a back portion located opposite to the tube opening, wherein the top flat base and the bottom flat base include a side fixing through hole at each side portion and a back fixing through hole at the back portion.

In one embodiment, a portion of the inlet sub-chamber is arranged between the tube opening and one side fixing though hole, while a portion of the outlet sub-chamber is arranged between the tube opening and the another side fixing though hole, wherein the back fixing through hole is arranged between a portion of the inlet sub-chamber and a portion of the outlet sub-chamber.

In one embodiment, the division wall is extending between the tube opening and the back fixing through hole.

Another object of the invention is a heat exchanger, comprising a fluid distribution tank including a top plate and a bottom plate coupled with each other to define a chamber with a tube opening; wherein the top plate includes a top flat base and a top chamber base raised above the top flat base, while the bottom plate includes a bottom flat base and a bottom chamber base raised above the bottom flat base, the top and bottom chamber bases defining the chamber; wherein the top flat base is arranged in contact with the bottom flat base so that the top chamber base and the bottom chamber base are raised therefrom in opposite directions, wherein the chamber is divided into an inlet sub-chamber and an outlet sub-chamber by a division wall; a fluid return tank; a flat tube connected to and extending between the fluid distribution tank and the fluid return tank; and a connecting block fluidically connected with the fluid distribution tank for providing the fluid to and receiving the fluid from the flat tube.

In one embodiment, the flat tube is extending between the fluid distribution tank and the fluid return tank along a meandering path.

Another object of the invention is a battery pack comprising a heat exchanger having a fluid distribution tank including a top plate and a bottom plate coupled with each other to define a chamber with a tube opening; wherein the top plate includes a top flat base and a top chamber base raised above the top flat base, while the bottom plate includes a bottom flat base and a bottom chamber base raised above the bottom flat base, the top and bottom chamber bases defining the chamber; wherein the top flat base is arranged in contact with the bottom flat base so that the top chamber base and the bottom chamber base are raised therefrom in opposite directions, wherein the chamber is divided into an inlet sub-chamber and an outlet sub-chamber by a division wall; a fluid return tank; a flat tube connected to and extending between the fluid distribution tank and the fluid return tank along a meandering path; a connecting block fluidically connected with the fluid distribution tank for providing the fluid to and receiving the fluid from the flat tube; a plurality of cylindrical battery cells, arranged in contact with the meandering flat tube.

### BRIEF DESCRIPTION OF THE DRAWINGS

The present invention will be described in greater detail below with reference to the drawings. In the drawings:

FIG. 1 shows a flat tube with a fluid distribution tank according to the invention;

FIG. 2 shows a fluid distribution tank according to the invention in a perspective view;

FIG. 3 shows a fluid distribution tank according to the invention in a perspective view with a portion of the flat tube;

FIG. 4 shows a bottom plate of the fluid distribution tank;

FIG. 5 shows a fluid return tank in a perspective view with a portion of the flat tube;

FIG. 6 shows a bottom plate of the fluid return tank;

FIG. 7 shows a portion of the flat tube in a perspective view; and

FIG. 8 shows a battery pack with a heat exchanger according to the invention.

### DETAILED DESCRIPTION OF THE INVENTION

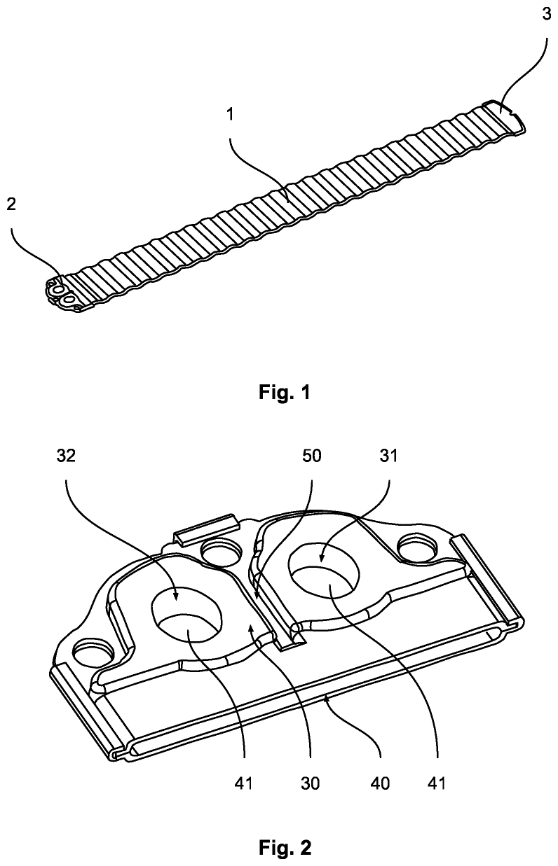

FIG. 1 shows a flat tube 1 with a fluid distribution tank 2 according to the invention. The flat tube 1 is connected to and is extending between the fluid distribution tank 2 and a fluid return tank 3. The fluid can enter the assembly through the fluid distribution tank 2, travel through the flat tube 1 in one way towards the fluid return tank 3, and then travel back through the flat tube 1 in the opposite way back to the fluid distribution tank 2. Subsequently, the fluid can exit the fluid distribution tank 2.

In one embodiment, the flat tube 1 is extending between the fluid distribution tank 2 and the fluid return tank 3 along a meandering path. In another embodiment (not shown) the flat tube 1 is extending along a straight path. This means that the fluid will travel between the fluid distribution tank 2 and the return tank 3 along a straight path.

FIG. 2 shows the fluid distribution tank 2 according to the invention in a perspective view. The fluid distribution tank 2 includes a chamber 30 for the fluid and a tube opening 40 for accepting the flat tube 1. The chamber 30 is divided into an inlet sub-chamber 31 and an outlet sub-chamber 32 by a division wall 50. Once the flat tube 1 is inserted into the tube opening 40, the fluid is prevented from travelling between the inlet sub-chamber 31 and the outlet sub-chamber 32 in any other way but through the flat tube 1.

The fluid distribution tank 2 includes also openings 41 enabling entering and exiting of the fluid.

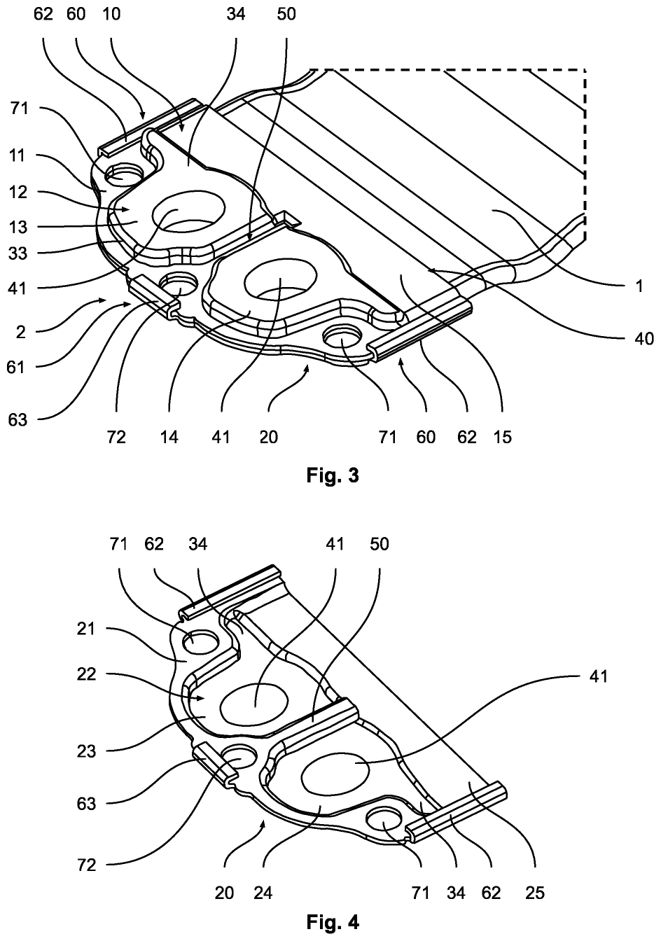

FIG. 3 shows the fluid distribution tank 2 according to the invention in a perspective view with a portion of the flat tube 1 The fluid distribution tank 2 includes a top plate 10 and a bottom plate 20 coupled with each other to define the chamber 30 and the tube opening 40.

The top plate 10 includes a top flat base 11 and a top chamber base 12 raised above the top flat base 11. The bottom plate 20 includes a bottom flat base 21 and a bottom chamber base 22 raised above the bottom flat base 21. The top and bottom chamber bases 12, 22 define together the chamber 30.

The top flat base 11 is arranged in contact with the bottom flat base 21 so that the top chamber base 12 and the bottom chamber base 22 are raised in opposite directions, e.g. perpendicularly to the them and away from each other. In this way, the chamber 30 is formed therebetween.

As described earlier in connection with FIG. 2, the chamber 30 is divided into the inlet sub-chamber 31 and the outlet sub-chamber 32 by the division wall 50. The inlet sub-chamber 31 is intended to receive the fluid coming to the fluid distribution tank 2 from the outside and supply it to the flat tube 1. The outlet sub-chamber 32 is intended to receive the fluid coming to the distribution tank 2 from the flat tube 1 and enable its further travel towards the outside of the distribution tank 2.

The inlet sub-chamber 31 and the outlet sub-chamber 32 are further defined by chamber sidewalls 33 extending between the top flat base 11 and the top chamber base 12 as well as between the bottom flat base 21 and the bottom chamber base 22.

In greater detail, the top chamber base 12 includes an inlet top chamber base 13 and an outlet top chamber base 14, separated from each other by the division wall 50. The bottom chamber base 22 includes an inlet bottom chamber base 23 and an outlet bottom chamber base 24, also, separated from each other by the division wall 50. The inlet sub-chamber 31 is formed by the inlet top chamber base 13 and the inlet bottom chamber base 23. The outlet sub-chamber 32 is formed by the outlet top chamber base 14 and the outlet bottom chamber base 24.

Each of the inlet top chamber base 13, the outlet top chamber base 14, the inlet bottom chamber base 23 and the outlet bottom chamber base 24 can include an opening 41 for the fluid. Consequently, if a plurality of fluid distribution tanks 2 with respective flat tubes 1 are connected to each other fluidically by their respective inlet and outlet sub-chambers 31, 32, the fluid that cannot enter one flat tube 1 is enabled to attempt entering a subsequent flat tube 1. Analogously, the fluid which exits one flat tube 1 merges with fluid exiting a subsequent flat tube 1.

Preferably, each of the inlet top chamber base 13, the outlet top chamber base 14, the inlet bottom chamber base 23 and the outlet bottom chamber base 24 has a flat surface with which the respective opening 41 for the fluid is flush. This enables them to function as pressure sealing surfaces for any gasket equipped connector block 102 attached thereto.

The chamber sidewalls 33 preferably extend at least partly perpendicular to the top flat base 11, the top chamber base 12, the bottom flat base 21 and the bottom chamber base 22. The space for the chambers 30 can in such case be efficiently utilized, in particular in connection with those bases 11, 12, 21, 22 being flat surfaces.

Further, the top plate 10 includes a top tube contact wall 15 raised above the top flat base 11, while the bottom plate 20 includes a bottom tube contact wall 25 raised above the bottom flat base 21. In this way, the top tube contact wall 15 and the bottom tube contact wall 25 form a tube receiving portion of the tube opening 40. With the top tube contact wall 15 and the bottom tube contact wall 25 being flat a solid and secure connection can be formed with the end portion of the flat tube 1, preferably through brazing.

Advantageously, the top tube contact wall 15 is raised from the top flat base 11 lower than the top chamber base 12, while the bottom tube contact wall 25 is raised from the bottom flat base 21 lower than the bottom chamber base 22. In this was the flat tube 1 can be accommodated without compromising the volume of the chamber 30 for the fluid.

The fluid distribution tank 2 as shown has two side portions 60 adjacent and extending perpendicular with respect to the tube opening 40 and a back portion 61 located opposite to the tube opening 40. The top plate 10 and the bottom plate 20 are connected to each other by means of side crimping tabs 62 located at the side portions 60 and a back crimping tab 63 located at the back portion 61. Preferably, the top flat base 11 and bottom flat base 12 are brazed together.

The top flat base 11 and the bottom flat base 21 can include a side fixing through hole 71 at each side portion 60 and a back fixing through hole 72 at the back portion 61. These enable connecting subsequent elements through the flat tube 1, in particular providing a sufficient pressing sealing force for any gasket equipped connector block 102 aligned with the flat surfaces of the fluid distribution tank 2.

In one embodiment, a portion of the inlet sub-chamber 31 can be arranged between the tube opening 40 and one side fixing though hole 71, while a portion of the outlet sub-chamber 32 can be arranged between the tube opening 40 and the another side fixing though hole 71. The back fixing through hole 72 can be arranged between a portion of the inlet sub-chamber 31 and a portion of the outlet sub-chamber 32. Such arrangement allows to securely and stably attach any suitable connector block to the fluid distribution tank 2, in particular ones utilizing the pressure sealing surfaces as described above, with uniform distribution of pressure with respect to the fluid distribution tank and its chamber 30.

FIG. 4 shows a bottom plate 20 of the fluid distribution tank 2. In addition to visualizing the elements described so far, it can particularly show how the division wall 50 is formed by portions of the top flat base 11 and the bottom flat base 21 being in sealing contact.

Advantageously, the division wall 50 extends between the tube opening 40 and the back fixing through hole 72, contributing thereby to over pressure resistance of the fluid distribution tank 2.

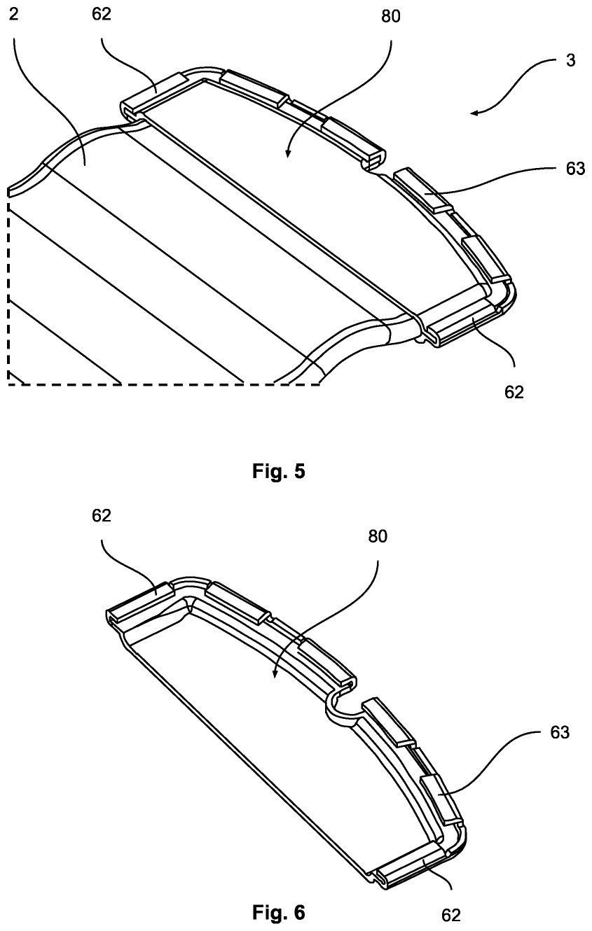

FIG. 5 shows a fluid return tank 3 in a perspective view with a portion of the flat tube 1. The fluid return tank 3 is formed by two plates connected by side crimping tabs 62 and back crimping tabs 63 similarly to as in case of the fluid distribution tank 1. Preferably, a brazed connection is made between the two plates and the flat tube 1. The two plates form a return chamber 80 as shown to enable the fluid to be received from the flat tube 1 and reintroduced thereto. FIG. 6 shows a bottom plate of the fluid return tank.

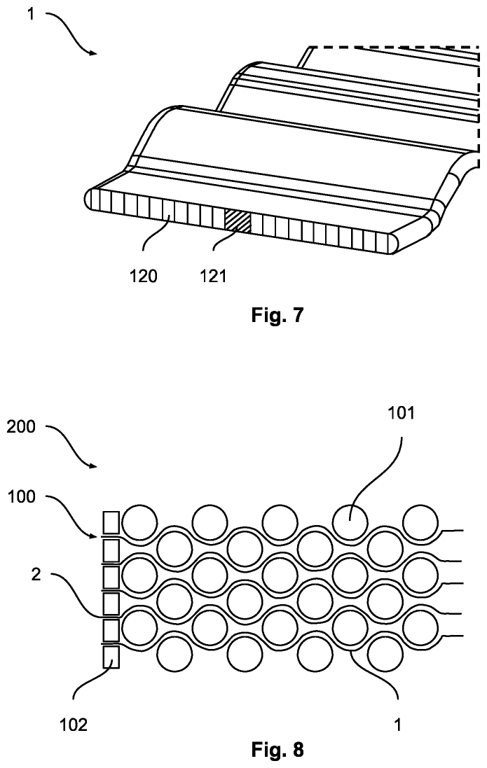

FIG. 7 shows a portion of the flat tube 1 in a perspective view. The flat tube 1 includes in this embodiment a plurality of separated fluid channels 120 enabling flow of the fluid along its path of extension. Individual fluid channels 120 can be separated from each other as in FIG. 7. There is also a blocking wall 121 between at least two fluid channels 120. In this manner, when one set of inlet channels 120 is attached directly to the inlet sub-chamber 31, while the other is connected directly to the outlet sub-chamber 32, due to presence of the blocking wall 121 U-flow of the fluid through the flat tube 1 is enabled with help of the return tank 3. Alternatively, the blocking wall 121 can be omitted if the division wall 50 is sealed with respect to the face of the flat tube 2 upon assembly, effectively blocking one or more of the centrally located fluid channels 120.

It is also envisioned that the flat tube 1 can be a straight tube extending between the fluid distribution tank 2 and the fluid return tank 3 along a straight, non-meandering path.

FIG. 8 shows schematically a battery pack 200 with a heat exchanger 100 according to the invention. The battery pack 200 includes a heat exchanger 100 having an assembly of the fluid distribution tank 2, the fluid return tank 3 and the flat tube 1 connected to and extending between the fluid distribution tank 1 and the fluid return tank 3 along a meandering path. Preferably, plurality of such sets is provided. At least one connecting block 102, preferably a plurality of connecting blocks 102, is fluidically connected with and between the fluid distribution tanks 2 for providing the fluid to and receiving the fluid from the flat tubes 1. A plurality of cylindrical battery cells 101 are arranged in contact with the meandering flat tube 2 so that heat can be exchanged therebetween to provide cooling and/or heating for the cylindrical battery cells 101. The meandering path accommodates in its curvatures the cylindrical outline of the cylindrical battery cells 101.

Other variations to the disclosed embodiments can be understood and effected by those skilled in the art in practicing the claimed invention, from a study of drawings, the disclosure, and the appended claims. The mere fact that certain measures are recited in mutually different dependent claims does not indicate that a combination of these measures cannot be used to the advantage.

What is claimed is:

1. A fluid distribution tank for a flat tube of a heat exchanger, comprising:
a top plate and a bottom plate coupled with each other to define a chamber with a tube opening;
wherein the top plate includes a top flat base and a top chamber base raised above the top flat base, while the bottom plate includes a bottom flat base and a bottom chamber base raised above the bottom flat base, the top and bottom chamber bases defining the chamber;
wherein the top flat base is arranged in contact with the bottom flat base so that the top chamber base and the bottom chamber base are raised therefrom in opposite directions,
wherein the chamber is divided into an inlet sub-chamber and an outlet sub-chamber by a division wall.

2. The fluid distribution tank according to claim 1, wherein the inlet sub-chamber and the outlet sub-chamber are further defined by chamber sidewalls extending between the top flat base and the top chamber base as well as between the bottom flat base and the bottom chamber base.

3. The fluid distribution tank according to claim 2, wherein the chamber sidewalls extend at least partly perpendicular to the top flat base, the top chamber base, the bottom flat base and the bottom chamber base.

4. The fluid distribution tank according to claim 1, wherein the top plate includes a top tube contact wall raised above the top flat base, while the bottom plate includes a bottom tube contact wall raised above the bottom flat base, so that the top tube contact wall and the bottom tube contact wall form a tube receiving portion of the tube opening.

5. The fluid distribution tank according to claim 4, wherein the top tube contact wall is raised from the top flat base lower than the top chamber base, while the bottom tube contact wall is raised from the bottom flat base lower than the bottom chamber base.

6. The fluid distribution tank according to claim 1, wherein the top chamber base includes an inlet top chamber base and an outlet top chamber base, while the bottom chamber base includes an inlet bottom chamber base and an outlet bottom chamber base, the inlet sub-chamber being formed by the inlet top chamber base and the inlet bottom chamber base, and the outlet sub-chamber being formed by the outlet top chamber base and the outlet bottom chamber base.

7. The fluid distribution tank according to claim 1, wherein the division wall is formed by portions of the top flat base and the bottom flat base being in contact.

8. The fluid distribution tank according to claim 1, wherein each of the inlet top chamber base, the outlet top chamber base, the inlet bottom chamber base and the outlet bottom chamber base includes an opening for the fluid.

9. The fluid distribution tank according to claim 8, wherein each of the inlet top chamber base, the outlet top chamber base, the inlet bottom chamber base and the outlet bottom chamber base has a flat surface with which the respective opening for the fluid is flush.

10. The fluid distribution tank according to claim 1, wherein top flat base and bottom flat base are brazed together.

11. The fluid distribution tank according to claim 1, having two side portions adjacent and extending perpendicular with respect to the tube opening and a back portion located opposite to the tube opening, wherein the top plate and the bottom plate are connected to each other by means of side crimping tabs located at the side portions and a back crimping tab located at the back portion.

12. The fluid distribution tank according to claim 1, having two side portions adjacent and extending perpendicular with respect to the tube opening and a back portion located opposite to the tube opening, wherein the top flat base and the bottom flat base include a side fixing through hole at each side portion and a back fixing through hole at the back portion.

13. The fluid distribution tank according to claim 12, wherein a portion of the inlet sub-chamber is arranged between the tube opening and one side fixing though hole, while a portion of the outlet sub-chamber is arranged between the tube opening and the another side fixing though hole, wherein the back fixing through hole is arranged between a portion of the inlet sub-chamber and a portion of the outlet sub-chamber.

14. The fluid distribution tank according to claim 13, wherein the division wall is extending between the tube opening and the back fixing through hole.

15. A heat exchanger, comprising
a fluid distribution tank including
a top plate and a bottom plate coupled with each other to define a chamber with a tube opening;
wherein the top plate includes a top flat base and a top chamber base raised above the top flat base, while the bottom plate includes a bottom flat base and a bottom chamber base raised above the bottom flat base, the top and bottom chamber bases defining the chamber;
wherein the top flat base is arranged in contact with the bottom flat base so that the top chamber base and the bottom chamber base are raised therefrom in opposite directions,
wherein the chamber is divided into an inlet sub-chamber and an outlet sub-chamber by a division wall;
a fluid return tank;
a flat tube connected to and extending between the fluid distribution tank and the fluid return tank; and
a connecting block fluidically connected with the fluid distribution tank for providing the fluid to and receiving the fluid from the flat tube.

16. The heat exchanger according to claim 15, wherein the flat tube is extending between the fluid distribution tank and the fluid return tank along a meandering path.

17. A battery pack comprising
a heat exchanger having
a fluid distribution tank including
a top plate and a bottom plate coupled with each other to define a chamber with a tube opening;
wherein the top plate includes a top flat base and a top chamber base raised above the top flat base, while the bottom plate includes a bottom flat base and a bottom chamber base raised above the bottom flat base, the top and bottom chamber bases defining the chamber;
wherein the top flat base is arranged in contact with the bottom flat base so that the top chamber base and the bottom chamber base are raised therefrom in opposite directions,
wherein the chamber is divided into an inlet sub-chamber and an outlet sub-chamber by a division wall;
a fluid return tank;
a flat tube connected to and extending between the fluid distribution tank and the fluid return tank along a meandering path;
a connecting block fluidically connected with the fluid distribution tank for providing the fluid to and receiving the fluid from the flat tube;
a plurality of cylindrical battery cells, arranged in contact with the meandering flat tube.
